(19) United States
(12) Patent Application Publication
(10) Pub. No.: US 2013/0110628 A1
(43) Pub. Date: May 2, 2013

(54) ADVERTISEMENT DETERMINATION SYSTEM AND METHOD FOR CLUSTERED SEARCH RESULTS

(71) Applicants: Boon-Lock Yeo, Los Altos Hills, CA (US); Gangjiang Li, Shanghai (CN)

(72) Inventors: Boon-Lock Yeo, Los Altos Hills, CA (US); Gangjiang Li, Shanghai (CN)

(73) Assignee: Google Inc.

(21) Appl. No.: 13/643,268

(22) PCT Filed: Oct. 28, 2011
(86) PCT No.: PCT/CN2011/081482

§ 371 Date: Oct. 24, 2012

(51) Int. Cl. G06Q 30/02

(52) U.S. Cl. 705/14.54

(57) ABSTRACT

A method for determining advertisements that includes, receiving, by a server computer, a query with one or more keywords. The method includes determining one or more category labels for the query based on at least one of the one or more keywords, historical search queries and historical search results. The method may determine one or more advertisements based on the one or more category labels. Data may be sent to the user computer display for one or more search results for the query, the search results are grouped by the one or more category labels and at least one advertisement is displayed for at least one category label.

### BACKGROUND

The Internet provides access to a wide variety of content. The ability to search that content and provide intelligent search results to a user continues to be a challenge. Moreover, providing advertisements for services or items that the user would like to purchase can be beneficial to both the users and the advertisers.

The accessible content provides an opportunity to place advertisements. Advertisements can be placed within content, such as a web page, image or video, or the content can trigger the display of one or more advertisements, such as presenting an advertisement in an advertisement slot and/or in a pop-up window.

Advertisers decide which ads are displayed within particular content using various advertising management tools. These tools also allow an advertiser to track the performance of various ads or ad campaigns. The parameters used to determine when to display a particular ad can also be changed using advertising management tools.

### SUMMARY

In general, one aspect of the subject matter described in this specification can be embodied in a method for providing advertising content to a user in response to a search request to be performed on the Internet. One embodiment is a method for determining advertisements includes, receiving, by a server computer, a query with one or more keywords. The method includes determining one or more category labels for the query based on the one or more keywords, historical search queries and historical search results. The method may determine one or more advertisements based on the one or more category labels. Data may be sent to the user computer display for one or more search results for the query, the search results are grouped by the one or more category labels and at least one advertisement is displayed for at least one category label.

Another embodiment may include an apparatus that includes, a server computer configured to receive a query that includes one or more keywords. The server computer is configured to determine one or more category labels for the query based on at least one of the one or more keywords, historical search queries and historical search results. The server computer configured to determine one or more advertisements based on the one or more category labels. The server computer configured to send data to a user computer so that the user computer is configured to display one or more search results for the query and the search results displayed to be grouped by the one or more category labels. The user computer configured to display at least one advertisement for at least one category label such that the advertisement was determined by the server computer.

A non-transitory computer readable storage media configured to store a program product that, when executed on at least one process performs a method that includes, receiving, by a server computer, a query with one or more keywords. The method includes determining one or more category labels for the query based on at least one of the one of more keywords, historical search queries and historical search results. The method may determine one or more advertisements based on the one or more category labels. Data may be sent to the user computer display for one or more search results for the query, the search results are grouped by the one or more category labels and at least one advertisement is displayed for at least one category label.

Particular embodiments of the subject matter described in this specification can be implemented so as to realize one or more of the following advantages, by clustering the results with category labels, the advertisements that are selected are more targeted to the categories. Accordingly, more relevant advertisements are selected and shown to the user. Increased relevance leads to the users being more likely to buy the services or products from the advertisements creating benefits for the advertisers and the users.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram of an example system in which advertisement images and search result images are combined and provided on a display consistent with an illustrative embodiment.

FIG. 2 is a method that is implemented by the systems shown in FIG. 1, according to an Illustrative embodiment.

FIG. 3 is en example illustration of the category table based on historical search activity, according to an example embodiment.

FIG. 4 is a flow diagram that may be implemented by the system shown in FIG. 1.

FIG. 5 shows an example of an image search result and an advertisement display consistent with an illustrative embodiment.

FIG. 6 is a block diagram of a computer system consistent with an illustrative embodiment.

Like reference numbers and designations in the various drawings indicate like elements.

### DETAILED DESCRIPTION

Many users of the internet employ search engines to search for particular information. When a user is provided with the search results, relevant advertisements can be provided together with the search results in a convenient manner, so as to maximize results for the advertisers and enhance the user experience.

The present specification is directed to an Internet advertisement providing system, method and computer program product, which enables image advertisements, such as ones provided by an advertisement-providing third party application, to be included with online search engine results. This may be performed so as to increase advertisement click revenue for the advertiser and to provide revenue for the provider of the online search engine. In addition, this may be performed to improve an end users experience by providing relevant content to the user.

As used throughout this document, user interactions are any presentation of content to a user and any subsequent affirmative actions or non-actions (collectively referred to as “actions” unless otherwise specified) that a user takes in response to presentation of content to the user (e.g., selections of the content following presentation of the content, or no selections of the content following the presentation of the content). Thus, a user interaction does not necessarily require a selection of the content (or any other affirmative action) by the user.

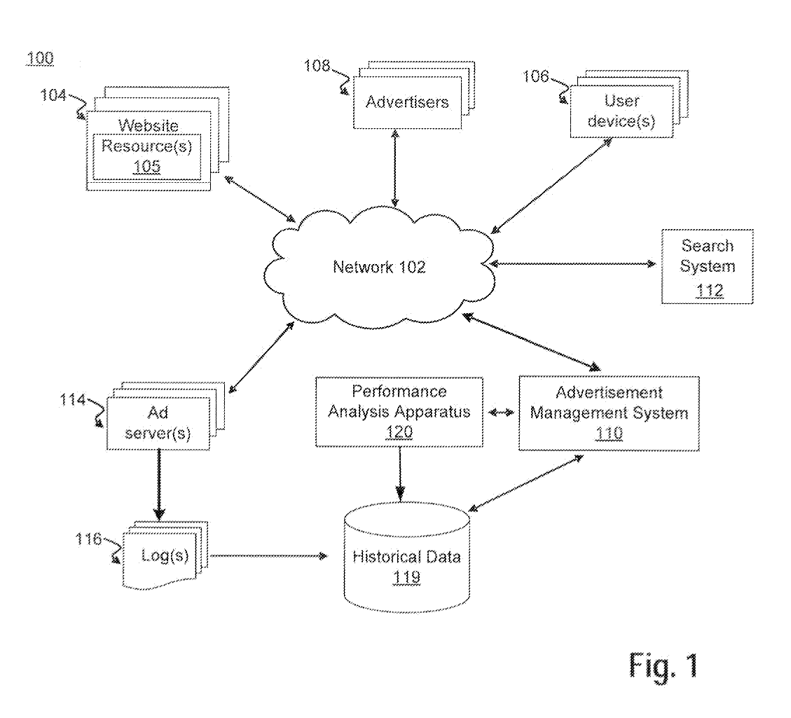

FIG. 1 is a block diagram of ah example environment in which an advertisement management system manages advertising services in accordance with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources include web pages, word processing documents, portable document format (PDF) documents, images, video, programming elements, interactive content and feed sources, to name only a few. The resources can include content, such as words, phrases, images and sounds, which may include embedded information (such as meta-information in hyperlinks) and/or embedded instructions (such as JavaScript™ scripts).

A user device 106 is an electronic device that is controllable by a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of the vast number of resources 105 accessible over the network 102, the environment 100 can include a search system 112 that identifies the resources 105 by crawling and indexing the resources provided on the websites 104. Data about the resources can be indexed based on the resource with which the data is associated. The indexed and, optionally, cached copies of the resources are stored in a search index (not shown).

User devices 106 can submit search queries to the search system 112 over the network 102. In response, the search system 112 accesses the search index to identify resources that are relevant to the search query. In one illustrative embodiment, a search query includes one or more keywords. The search system 112 identifies the resources in the form of search results and returns the search results to the user devices 106 in search results pages. A search result is data generated by the search system 112 that identifies a resource that is responsive to a particular search query, and includes a link to the resource. An example search result can include a web page title, a snippet of text or a portion of an image extracted from the web page, a rendering of the resource, and the URL of the web page. Search results pages can also include one or more advertisement slots in which advertisements can be presented. In an example implementation, the search results may be sorted by subject or categories. Each category includes a label and search results that belong to the category. Advertisements that are most relevant to the category or the category label may be displayed in advertisement slots that are adjacent to the search results for the category. Accordingly, relevant advertisements related to the category or the category label may be displayed for a user.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifiers are anonymized and are not connected with user names. Because HTTP is a stateless protocol, the use of cookies allows an external service, such as the search system 112 or other system, to track particular actions and status of a user over multiple sessions. A user may, at any time, opt out of tracking user actions, for example, by disabling cookies in the browser's settings. The search system 112 does not track user identifying information.

When a resource 105 or search results are requested by a user device 106, the advertisement management system 110 receives a request for advertisements to be provided with the resource 105 or search results. The request for advertisements can include characteristics of the advertisement slots that are defined for the requested resource or search results page, and can be provided to the advertisement management system 110. For example, a reference (e.g., URL) to the resource for which the advertisement slot is defined, a size of the advertisement slot, and/or media types that are available for presentation in the advertisement slot can be provided to the advertisement management system 110. Similarly, keywords (i.e., one or more words that are associated with content) associated with a requested resource (“resource keywords”) or a search query for which search results are requested can also be provided to the advertisement management system 110 to facilitate identification of advertisements that are relevant to the resource or search query.

Using data included in the request for advertisements, the advertisement management system 110 can select advertisements that are eligible to be provided in response to the request (“eligible advertisements” or “candidate advertisements”). For example, eligible advertisements can include advertisements having characteristics matching the characteristics of advertisement slots and that are identified as relevant to specified resource keywords or search queries. In some implementations, advertisements having targeting keywords that match the resource keywords or the search query are selected as eligible advertisements by the advertisement management system 110.

The advertisement management system 110 selects an eligible advertisement for each advertisement slot of a resource 105 or of a search results page. The resource 105 or search results page is received by the user device 106 for presentation to the user. User interaction data representing user interactions with presented advertisements can be stored in an historical data store 119. For example, when an advertisement is presented to the user via an ad server 114, data can be stored in a log file 116. This log file 116, as more fully described below, can be aggregated with other data in the historical data store 119. Accordingly, the historical data store 119 contains data representing the advertisement impression. For example, the presentation of an advertisement is stored in response to a request for the advertisement that is presented. For example, the ad request can include data identifying a particular cookie, such that the data identifying the cookie can be stored in association with data that identifies the advertisement(s) that were presented in response to the request. In some implementations, the data can be stored directly to the historical data store 119.

Similarly, when a user selects (e.g., clicks) a presented advertisement, data can be stored in the log 116 or the historical data store 119 representing the selection of the advertisement. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction date can be associated with unique identifiers, each representing a corresponding user device with which the user interactions were performed. For example, in some implementations, user interaction data can be associated with one or more cookies. Each cookie can include content that specifies an initialization time that indicates a time at which the cookie was initially set on the particular user device 106.

The logs 116 or the historical data store 119 also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions that each advertisement has received, and the number of impressions for each advertisement can be delineated, for example, using the keywords that caused the advertisement to receive impressions and/or the cookies that are associated with the impressions. The logs 116 may include intelligence information regarding previously conducted searches queries, search results that may have been selected for each search query, advertisements that the users selected based on the search queries and other information to help determine the category for search terms.

Data for each impression can also be stored so that each impression and user selection can be associated with (i.e., stored with references to and/or indexed according to) the advertisement that was selected and/or the targeting keyword that caused the advertisement to be selected for presentation. The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements.

The campaign performance report can also, provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword “hockey” can be attributed with 1,000 impressions, 20 clicks, and 5 conversions.

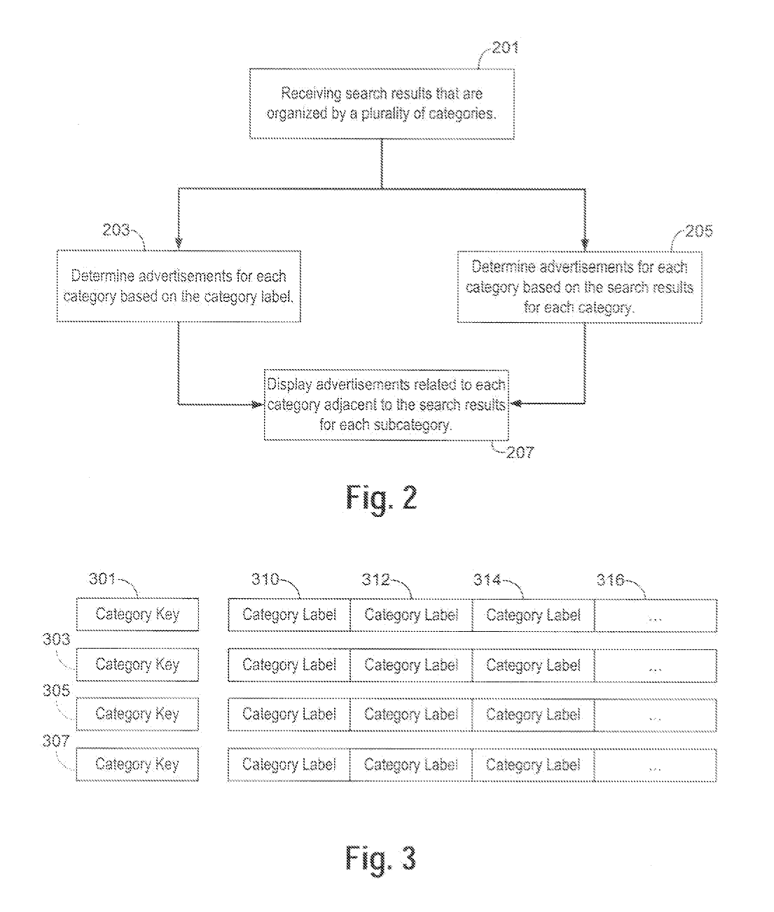

Various methods may be implemented using the system from FIG. 1. For example, FIG. 2 is a method that is used to display advertisements related to categories within search results. At block 201, search results organized in a plurality of categories may be determined, and each category may have a category label. The plurality of categories may be generated based on historical search results performed on the search system 112. For example, searches that were performed on the search system 112 may be stored in logs 116. User selection of search results is stored in order to determine the categories for various query terms. The search system 112 generates a category table, as shown in FIG. 3, which has a plurality of query keys each relating to a plurality of query labels. The query labels each represent one category that may be displayed based on a weighted likelihood that a user will select s particular result generated based on the query and the category.

Blocks 203 and 205 may be performed as part of a single method, in parallel or one after another. At block 203, the system 100 determines advertisements for each category based on a category label. A category label may be determined by comparing the terms in the search query with the historical data 119. Determining the advertisements for each category may include performing a search in the advertisement management system 110 for advertisements that have been previously selected when a user queried the category label. Alternatively, the advertisement may be selected based on the search result with the highest click through rate for the category key and the category label. In other implementations, the advertisement(s) that with the highest click through rate may be predetermined for each category prior to requesting the search results for a search query. Accordingly, the system may choose an advertisement from a plurality of predetermined advertisement(s) based on the category label.

At block 205, the advertisement management system 110 may determine advertisements for each category based on the search results for each category. At block 205, the search results for each category may be used to conduct a search, by the ad server 114, to determine an appropriate advertisement for each category. Terms from each result that belong to a category may be used to create a Boolean logic expression to create a search for the advertisements. Alternatively, a weighted average of various terms may be used to prioritize the results. The weighted average may be determined based on terms that are common to other search results. For example, terms that are common may be given a higher weight than other terms that don't repeat as many times as other terms.

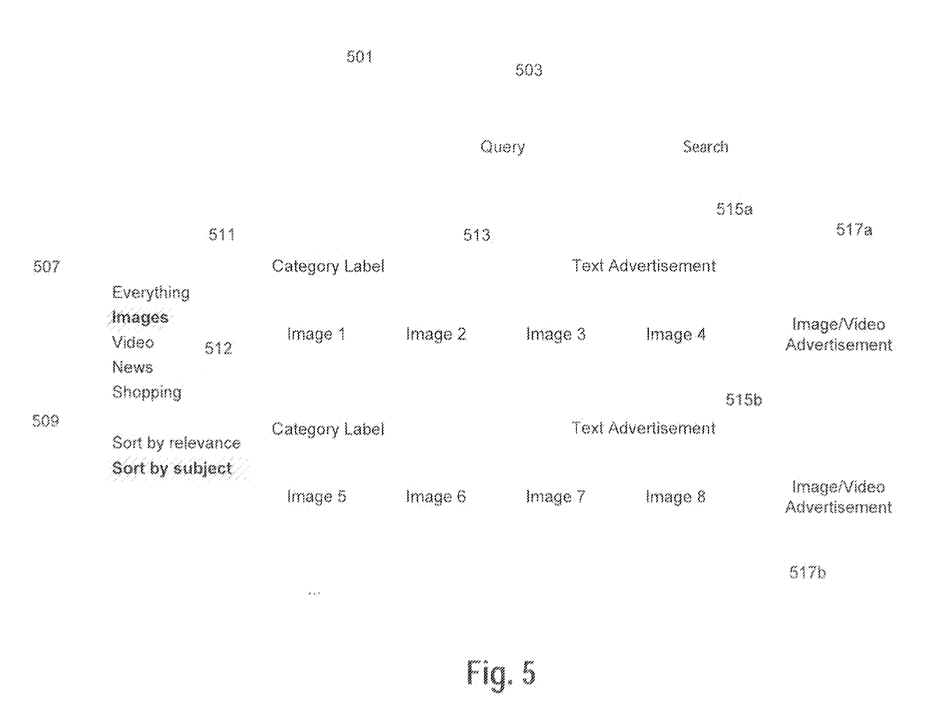

At block 207, the advertisements that are related to each category are placed to be adjacent to the search results. In various implementations, adjacent may be next to, without other content in between, in the victim, in the same portion of the display, in the same line. In another embodiment, the advertisement may be placed in the same line as the category label. In another embodiment the advertisement may be placed in the same line as the category label and about the search results. The advertisements may include, text, hyperlink, image or video messages for the user. The selected advertisements may be included in the categorized search results that will be displayed to the user. An example of the displayed advertisements is shown in FIG. 5.

FIG. 3 is an example illustration of a query category table based on historical seared activity, according to an example embodiment. The query table shown in FIG. 3 includes a plurality of category keys, such as, category key 301, category key 303, category key 305, and category key 307. In various embodiments, the system 100 may have a plurality of category keys. As shown in FIG. 3, each category key has a plurality of category labels. For example, category key 301 may include category label 310, category label 312, category label 314 and other labels 316. The content of the category keys and category labels may be generated by analyzing previous search logs and by analyzing internal databases, such as but not limited to, dictionary, thesaurus, and other known databases. Advertisements determined based on category labels and keys provide a user with advertisements that are more relevant to the search results than generating advertisements that are based on the search query. In an example embodiment, the category labels may be used to find the most relevant advertisements. For example, if the category key is “animal”, the category labels may include “tiger”, “lion” and etc. The category label “tiger” may be used as a keyword to search for advertisement database to select the most relevant advertisements for the category label.

Upon parsing the search query received from the user each word in the query may be matched with a predefined category key and/or the query labels that belong to the category key may be used as the labels for the search result. Moreover, the query labels may be used to search for advertisements for each category within the results. In other embodiments, when a user query includes two or more category keys, a determination may be made based on weighing which category key has a higher rating. The higher rating determination may be based on based on past searching activity by the user or based on past search activity based on other users.

An example category key 301 may be the term or the image of an “animal”. An example category label 310 for category key 301 may be the term or the image of a “lion”. Similarly, category label 312 may be “tiger”, category label 314 may be “dog”, and “eagle” and so on. In this example, the category labels are different types of animals. Accordingly, in this example, when a user query includes the term “animals” the search results would be sorted with the following labels, “tiger”, “dog”, “eagle” and so on. Moreover, advertisements related to each label would be displayed to be adjacent to the category label and related search results. Other examples of category key may be “cars” and the category labels may be “cars the movie, “cars wallpaper”, “sports cars”, “muscle car” and so on.

When the search query from the user includes a term that is a category label, the search system 112 may use other category labels that are common to the category key of the category label. Based on the results of a comparison between the search terms and the category labels, a set of query labels may be extrapolated and the search results may be sorted based on the query labels.

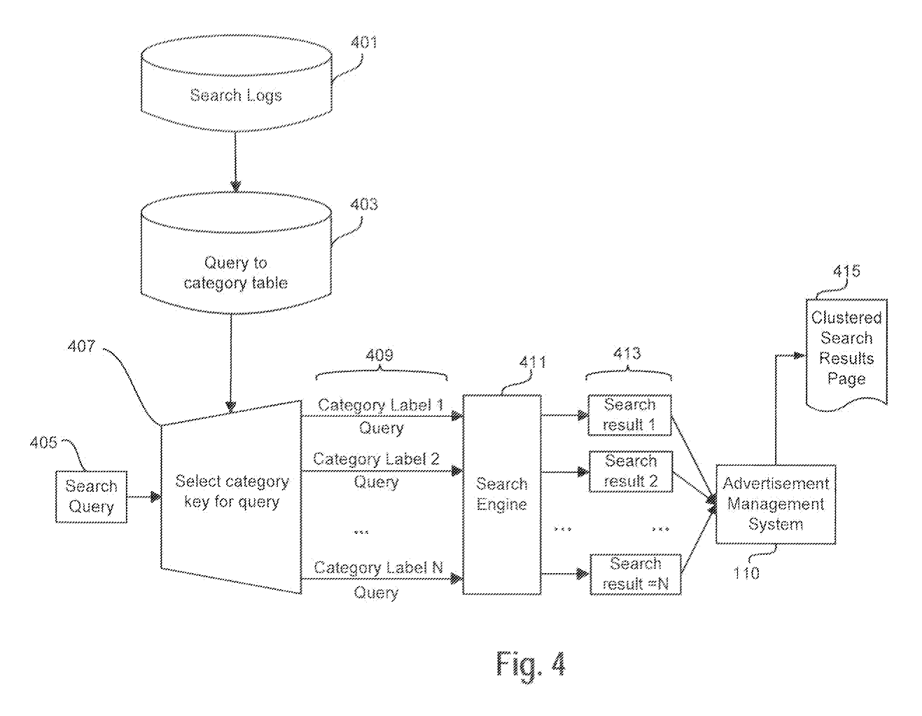

FIG. 4 is a process flow diagram that shows a process that may be implemented by the system from FIG. 1. The process from FIG. 4 may be implemented using one or more systems from FIG. 1. In an example embodiment, the search logs 401 may be a compilation of data from logs 116 and historical data store 119. The search logs 401 may include data that represents searches and results that were generated for previously conducted searches. The query category table 403 as shown in FIG. 3 may be generated by analyzing the search logs 401. Each category key is associated with a plurality of category labels. The query category table 403 may be populated with data prior to the user typing in a search query 405. In another embodiment, portions of the query category table 403 may be predetermined and other portions may be determined based on the most recent search results. Historical data may be searched for patterns to determine category keys and category labels. In one embodiment, the category table may include data from various time periods, such as but not limited to, 30 days, 60 days, 90 days, 1 year or more. In an alternative implementation, data from one or more years prior to the submission of the query 405 may be used. In an alternative implementation, data from the same day a year ago from the date of submission of the query 405 may be used.

The search system 112 may receive a search query 405 from a user. Based on the words in the search query the search system 112 determines one or more category keys and related category labels. In an example embodiment, other systems may determine one or more categories. In an example embodiment, the search system 112 may generate a plurality of search queries 409 each comprising a combination of the search query 405 and the selected category labels 407. The plurality of search queries 409 are sent to the search engine 411 to ascertain a set of search results (label results 413) for each search query 409. The search engine 411 generates a set of search results 413 for each search query 409 such that each set has an order such that the results that are more likely to be selected by a user are displayed before the other search results.

Once the search results 413 are generated each set of search results with their respective category label is sent to the advertisement management system 110 to determine at least one advertisement for each set of search results. As described in FIG. 2, the advertisement management system 110 may determine the advertisements that may be displayed. The advertisements may be selected based on conducting a search for the advertisement by using the category labels and the search results generated from the plurality of search queries 409. The advertisements that are selected may be text, image, video or a combination of various types of advertisements. Each advertisement may include hyperlinks to an advertiser selected URL.

Once the advertisements are selected, they are sent to a user device to be displayed in a location relative to the search results such that the advertisements are placed adjacent to or otherwise relative to the search results on the search results page 415. The search results page 415 may display the search results and the advertisements in rows or columns as shown in the screen shot in FIG. 5.

FIG. 5 shows a screen shot 501 as an example of an image search result page with advertisements being displayed consistent with an illustrative embodiment. The system 100 may receive a query 503 from a user to search for images. The user may search for any type of result, such as but not limited to, images, video, everything, news, shopping or the like. In the example embodiment shown in FIG. 5, the user is searching for images. In other embodiments similar displays may be generated for other search criteria.

As shown in FIG. 5 the user selected images 507 in order to choose an image search. Moreover, the user selected the sort by subject 509 option. The screen shot 501 shows a plurality of categories for example category label 511 and images 513 below the category label 511. Text advertisement 515a may be displayed above the search results images 1, 2, 3, and 4. In another embodiment an image/video advertisement 517a may be displayed in the same row as the search results for one category label. The advertisements 515a and 517a are associated with category label 511. Other category labels such as category label 512 may also be displayed and advertisements associated with category label 512 such as, text advertisement 515b and image/video advertisement 517b may also be displayed. Displaying the advertisements next to the results and the category label allows a user to see more relevant advertisements than just displaying advertisements based on the user query.

In one embodiment, the advertisements may include one or more of text, hyperlinks, and an indication that the display is an advertisement. For example, the advertisement may state, “ads”. In one example embodiment, the advertisement may be displayed in a variety of ways, such as but not limited to, above the search results, at the vertical height of the category label, or same line as the category label.

The advertisement management system 110, the performance analysis apparatus 120, elements of system 600, or other elements described herein can be realized by instructions embodied in a non-transitory tangible storage media that upon execution cause one or more processing devices to carry out the processes and functions described above. Such instructions can comprise, for example, interpreted instructions, such as script instructions, e.g., JavaScript or executable code, or other instructions stored in a computer readable medium. The advertisement management system 110 and/or the performance analysis apparatus 120 can be distributively implemented over a network, such as a server farm, or can be implemented in a single computer device.

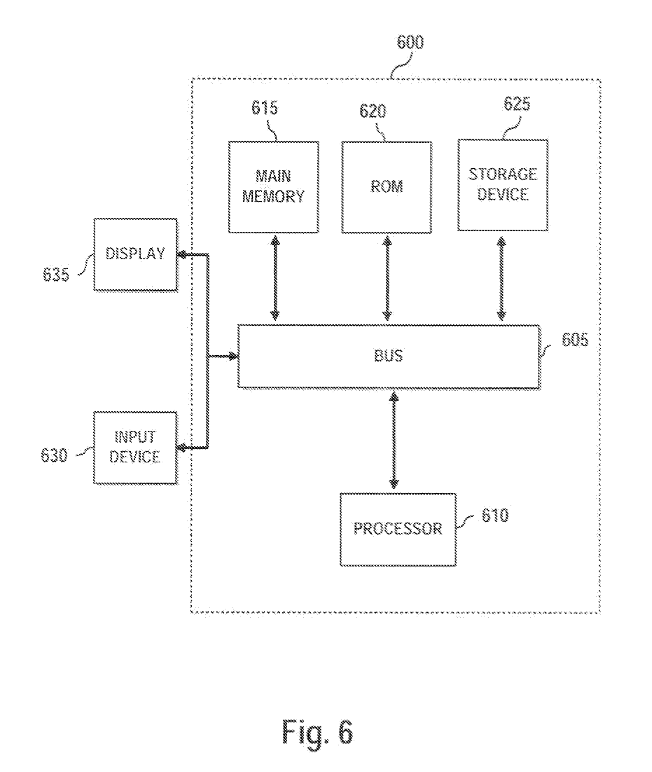

FIG. 6 illustrates a depiction of a computer system 600 that can be used to provide user interaction reports, process log files, implement an illustrative performance analysis apparatus 120, and/or implement an illustrative advertisement management system 110. The computing system 600 includes a bus 605 or other communication mechanism for communicating information and a processor 611 coupled to the bus 605 for processing information. The computing system 600 also includes main memory 615, such as a random access memory (RAM) or other dynamic storage device, coupled to the bus 605 for storing information, and instructions to be executed by the processor 611. Main memory 615 can also be used for storing position information, temporary variables, or other intermediate information during execution of instructions by the processor 611. The computing system 600 may further include a read only memory (ROM) 620 or other static storage device coupled to tire bus 505 for storing static information and instructions for the processor 611. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information, and command selections to the processor 611. In an embodiment, the input device 630 has a touch screen display 635. The input device 630 can include a cursor control, such as a mouse, a trackball, or cursor direction keys, for communicating direction information and command selections to the processor 611 and for controlling cursor movement on the display 635.

According to various embodiments, the processes that effectuate illustrative embodiments that are described herein can be implemented by the computing system 600 in response to the processor 611 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative embodiments, hard-wired circuitry may be used in place of or in combination with software instructions to implement illustrative embodiments. Thus, embodiments are not limited to any specific combination of hardware circuitry and software.

In another embodiment, instead of the user initiating a search by entering a search phrase to perform a search of a particular media type or media types, information can be pushed to the user history information. The user history information can be, for example, information corresponding to web sites visited by the user within the current user session or the last few user sessions. For example, if the user visits a first fashion handbag company web site and a second fashion handbag company web site, then advertisement data of the first and second fashion companies and other high-end handbag manufacturers can be pushed to the user when the user visits one or more of these web sites during a user session. Thus, instead of information being pulled from a user based on input by the search (e.g., a key word search input), in which relevant advertisements are matched with searched information of a particular media type, in this other embodiment, relevant advertisement information is pushed to the user based on a history of web sites which the user has visited recently. In one particular implementation of this embodiment and referring to the example above, the history information is used to push high priced handbag advertisements to the user together with search results obtained from a search request made by the user, even when the search request is unrelated to high priced handbags. So, if the user requested search results to be performed on a particular professional football team, and whereby the user had previously visited the first and second fashion handbag company web pages prior to conducting the search, relevant advertisements may be pushed to the user in a search results display screen, in which those advertisements are directed to handbags made by the first and second fashion companies that are related to the particular professional football team (e.g., have that team's logo somewhere on the handbag).

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A tangible or non-transitory computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program m question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and if can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, while certain embodiments have been described with respect to searching of a single media type, i.e., image search or video search, one or more embodiments are also relevant to a generic search where the search results are blended with different media types. Thus, for example, a user can type in a keyword search phrase into an internet search engine and obtains results that contain images, video and other media types blended with text results, and in which relevant matching advertisements are obtained (and provided to the user) that match one or more of these multi-media search results. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for selecting advertisements, comprising:
receiving, by a server computer, a query with one or more keywords;
identifying at least one category label for the query based on the one or more keywords;
selecting at least one advertisement based on the at least one category label;
sending data to a user computer, the data configured to cause a display to:
display at least one search result for the query, the at least one search result grouped by the at least one category label; and
display at least one advertisement for the at least one category label.

2. The method of claim 1,
wherein the at least one category label is linked to a category key;
wherein the links between the category key and the at least one category label is determined based on historical search queries and search results that were conducted by a plurality of users prior to receiving the query.

3. The method of claim 1, wherein selecting the at least one advertisement includes searching an advertisement system for advertisements that match the at least one category label.

4. The method of claim 3, wherein at least one advertisement includes a textual description and a URL.

5. The method of claim 4, wherein the textual description includes at least a portion of the at least one category label.

6. The method of claim 1, wherein the at least one category label is identified based on at least one of historical search queries, historical search results, and keywords associated with the advertisements found in the search.

7. The method of claim 1, wherein the at least one advertisement is displayed adjacent to the search result and the at least one category label.

8. An apparatus, comprising:
a server computer configured to receive a query that comprises at least one keyword;
the server computer configured to identify at least one category label for the query based on the at least one keyword;
select, using the server computer, at least one advertisement based on the at least one category label;
the server computer configured to send display data representing the at least one search result for the query, the at least one search result grouped by the at least one category label, the display data further representing at least one advertisement for the at least one category label.

9. The apparatus of claim 8, wherein
the at least one category label are linked to a category key;
wherein the links between the category key and the at least one category label is identified based on historical search queries and search results that were conducted by a plurality of users prior to receiving the query.

10. The apparatus of claim 8, wherein selecting the at least one advisement includes, an advertisement system searching for advertisements that match the one or more category labels.

11. The method of claim 10, wherein the at least one advertisement includes a textual description and a URL.

12. The method of claim 11, wherein the textual description includes at least a portion of the at least one category label.

13. The apparatus of claim 8, wherein the at least one category label is identified based on at least one of historical search queries, historical search results, and keywords associated with the at least one advertisement found in the search.

14. The method of claim 8, wherein the at least one advertisement is displayed adjacent to the at least on search result and the at least one category label.

15. A tangible computer readable storage media configured to store a program product that, when executed on at least one process performs a method comprising:
receiving a query having at least one keyword;
identifying at least one category label for the query based on the at least one keyword;
selecting at least one advertisement based on the at least one category label;
sending data to a user computer to:
display at least one search result for the query, the at least one search result grouped by the at least one category label; and
display at least one advertisement for the at least one category label.

16. The tangible computer readable storage media of claim 15,
wherein the at least one category label is linked to a category key;
wherein the links between the category key and the at least one category label is determined based on historical search queries and search results that were conducted by a plurality of users prior to receiving the query.

17. The tangible computer readable storage media of claim 15, wherein selecting the at least one advisement includes searching an advertisement system for at least one advertisement that matches the at least one category label.

18. The tangible computer readable storage media of claim 17,
wherein the at least one advertisement includes a textual description and a URL;
wherein the textual description includes at least a portion of the at least one category label.

19. The tangible computer readable storage media of claim 17, wherein the at least one advertisement indicates that it is an advertisement.

20. The tangible computer readable storage media of claim 15, wherein the at least one advertisement is displayed adjacent to the search results and the at least one category label.

21. The tangible computer readable storage media of claim 15, wherein the at least one category label is determined based on at least one of historical search queries, historical search results, and keywords associated with the advertisements found in the search.
